(19) United States
(12) Patent Application Publication
(10) Pub. No.: US 2006/0281379 A1
(43) Pub. Date: Dec. 14, 2006

(54) Breathable, water resistant fabric

(75) Inventors: Christine Haas, Ontario (CA); Sylvain Dufresne-Nappert, Ontario (CA)

Correspondence Address: WOOD, PHILLIPS, KATZ, CLARK & MORTIMER, 500 W. MADISON STREET, SUITE 3800, CHICAGO, IL, 60661, US

(73) Assignee: Fabrene Inc.

(21) Appl. No.: 11/204,431

(22) Filed: Aug. 16, 2005

(30) Foreign Application Priority Data
Jun. 10, 2005 (CA) 2,509,749

(51) Int. Cl. B32B 5/26; B32B 27/12; B32B 27/04

(52) U.S. Cl. 442/36; 442/35; 442/38; 442/41; 442/43; 442/45; 442/77; 442/79; 442/85; 442/86; 442/394; 442/398; 442/401

(57) ABSTRACT

A breathable, water resistant fabric comprising a reinforcing layer, a barrier layer applied to the reinforcing layer and a a breathable first protective layer covering at least a portion of the barrier layer. The reinforcing layer has a first side and a second side and includes a plurality of openings or passageways extending between its first and second sides to render the reinforcing layer breathable.

### FIELD OF THE INVENTION

This invention relates generally to the field of breathable, water resistant fabrics, and in one particular embodiment to a new and improved breathable, water resistant fabric that may be used for covers, tarpaulins, roofing enclosures and in the residential and commercial construction industries. In a further embodiment the invention relates to such a fabric for use as a roofing underlayment or housewrap.

### BACKGROUND OF THE INVENTION

Breathable and water resistant or waterproof fabrics are being used in an ever increasingly wide variety of different applications. Such materials are designed to present a barrier that is generally impervious to the transmission of water or liquids in order to protect objects or areas over which they are placed. At the same time, the fabric allows for water vapour to pass through it to prevent the trapping of excessive moisture and the resulting undesirable effects of condensation, water damage, mould and mildew.

Traditionally, outside of the clothing industry the use of breathable water resistant fabrics has been to a large extent limited to specially designed covers for vehicles, machinery and other specific objects. More recently, such fabrics have been used for roofing enclosures and in the residential and commercial building industries. In residential and commercial construction, fabrics of this nature are beginning to be used as housewrap and as a roofing underlayment on account of their ability to repel water or act as a liquid barrier and their ability to “breathe” or limit the build up of excess water vapour or humidity. p In the past breathable water resistant fabrics for use in non-clothing applications were often manufactured from canvass or synthetic blends (such as polyester or nylon) with a microporous film applied to one side. The microporous film provided both water resistance and breathability to the fabric through the incorporation of pores or passageways that extended through the film. The size of the pores was sufficiently small to prevent water from passing through the film but large enough to allow for water vapour to permeate the layer. Others have since proposed the application of a breathable layer to a strength enhancing substrate to form a light weight product having increased tensile strength and being less susceptible to rot. Examples of such prior existing products are described in U.S. Pat. No. 6,308,482 dated Oct. 30, 2001, U.S. patent application Ser. No. 10/702,689 published May 12, 2005 under publication number 2005/0097857 and Canadian patent application 2,451,068 published Dec. 27, 2002.

While such prior breathable water resistant or waterproof fabrics are generally effective in providing a liquid impervious barrier that permits the transmission of water vapour through it, they have tended to be of a multi-layer or laminate type construction where the microporous film or membrane is laminated, adhered or otherwise attached to either the upper or lower surface of a substrate. Unfortunately, microporous films or membranes tend to be relatively fragile and have little inherent tensile strength or abrasion resistence. Accordingly, when fused or otherwise adhered to the surface of a substrate such films or membranes are highly susceptible to damage which may occur during transportation, installation or use. Any breach in the relatively thin and fragile film or membrane represents a point for potential liquid infiltration.

### SUMMARY OF THE INVENTION

The invention therefore provides a breathable water resistant fabric that addresses some of the deficiencies in currently existing products and that reduces the likelihood for damaging the microporous film, breathable membrane or breathable barrier layer in a multi-layer fabric.

Accordingly, in one embodiment of the invention there is provided a breathable, water resistant fabric comprising a reinforcing layer having a first side and a second side and including a plurality of openings or passageways extending between said first and said second sides to render the reinforcing layer breathable; a barrier layer applied to said reinforcing layer such that said barrier layer imparts water resistency to said reinforcing layer while maintaining the breathability of said fabric to permit the movement of water vapour therethrough; and, a breathable first protective layer covering at least a portion of said barrier layer.

In a further aspect the invention provides a multi-layered breathable water resistant fabric comprising upper and lower protective layers, each of said protective layers containing pores, openings or passageways extending therethrough to render the layers breathable and to permit the transmission of water vapour through said layers; an intermediate reinforcing layer positioned between said upper and said lower protective layers, said reinforcing layer providing strength to said fabric and including pores, openings or passageways extending therethrough rendering said reinforcing layer breathable; and, a barrier layer comprising a laminate extrudate applied to a first side of said reinforcing layer such that said extrudate covers said first side of said reinforcing layer thereby imparting water-resistance to said fabric while maintaining the breathability of said fabric to permit the flow of water vapour therethrough.

The invention also concerns a method of manufacturing a multi-layered breathable water resistant fabric, the method comprising extrusion laminating an upper protective layer and a lower protective layer to opposite sides of a reinforcing layer through the use of a laminate extrudate, said reinforcing layer including a plurality of openings or passageways extending therethrough, said laminate extrudate covering a first side of said reinforcing layer and providing a means to adhere said upper protective layer to said multi-layered fabric, said laminate extrudate further extending through said openings in said reinforcing layer and providing a means to adhere said lower protective layer to said multi-layered fabric, wherein said upper and said lower protective layers are breathable and said laminate extrudate comprises a barrier layer imparting water resistance to said fabric while maintaining breathability to permit the flow of water vapour therethrough.

Further aspects and advantages of the invention will become apparent from the following description taken together with the accompanying drawings.

### BRIEF DESCRIPTION OF THE DRAWINGS

For a better understanding of the present invention, and to show more clearly how it may be carried into effect, reference will now be made, by way of example, to the accompanying drawings which show the preferred embodiments of the present invention in which:

FIG. 1 is a side section pictorial view of a breathable water resistant fabric constructed in accordance with a preferred embodiment of the present invention;

FIG. 2 is a lower perspective pictorial view of the fabric shown in FIG. 1 having its lower protective layer removed; and,

FIG. 3 is a schematic drawing of a process that may be used to manufacture the fabric shown in FIG. 1.

### DESCRIPTION OF THE PREFERRED EMBODIMENT

The present invention may be embodied in a number of different forms. However, the specification and drawings that follow describe and disclose only some of the specific forms of the invention and are not intended to limit the scope of the invention as defined in the claims that follow herein.

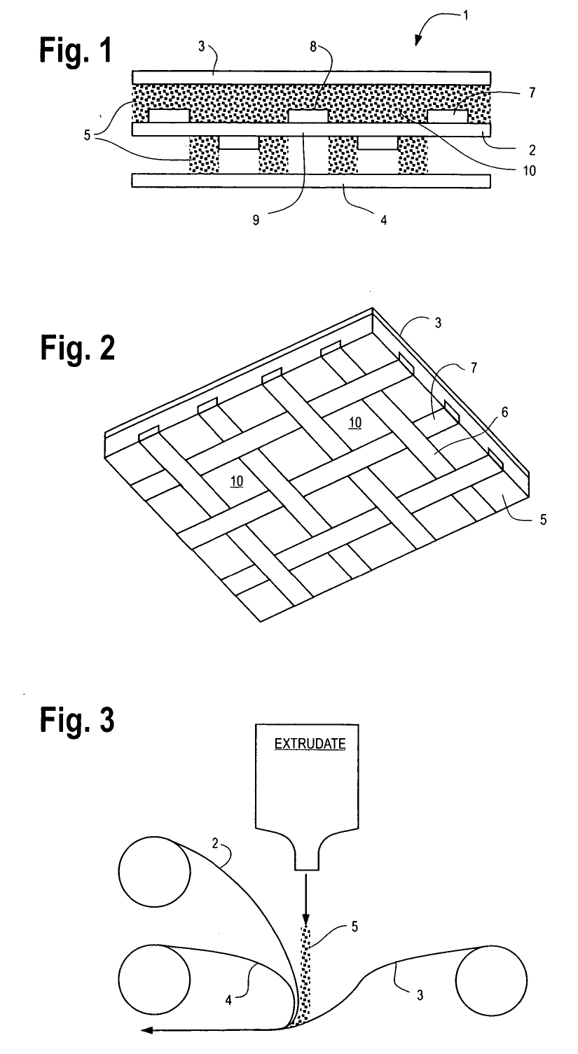

FIG. 1 shows in a pictorial cross-sectional view one of the preferred embodiments of the present invention. In FIG. 1 a breathable water resistant fabric pursuant to the invention is noted generally by reference numeral 1 and comprises a multi-layered structure formed from a breathable reinforcing layer 2, a breathable first or upper protective layer 3, a breathable second or lower protective layer 4 and a breathable barrier layer 5. Here, fabric 1 is of a “sandwich-type” structure with reinforcing layer 2 positioned between the first and second protective layers and barrier layer 5 providing water resistency to the fabric. Those skilled in the art will of course understand that the degree to which a product must be impervious to liquid water in order to be considered to be either “water resistant” or “waterproof” can vary depending upon the particular end use of the product. That is, for certain applications a fabric that remains impervious to liquid water for many hours when exposed to water under normal atmospheric conditions may be viewed as “waterproof”. However, the same fabric may not be considered to be “waterproof” in applications involving elevated temperatures and pressures, and where the fabric is required to remain completely impervious to stagnant or running liquid water for extended or indefinite periods. For that reason the fabric of the present invention is described as being water resistant. However, for many application it may also fulfill the requirements of a “waterproof” fabric.

The primary purpose of reinforcing layer 2 is to provide tensile and tear strength to the product in multiple directions. To accomplish that function reinforcing layer 2 may be comprised of a wide variety of different structures and/or materials. In the embodiment shown, reinforcing layer 2 is formed from a woven scrim of high density polyethylene tapes 7. In an alternate embodiment the scrim could be formed from any one or more of a number of different materials including, but not limited to, glass, Kevlar™, nylon, polyester, polypropylene or other polyolefin tapes and/or fibres and/or filaments. Where the reinforcing layer is a woven product it will be appreciated that the type of weave may vary (for example a plain weave, leno weave, etc) and that in general the more “open” the weave the more breathable the fabric will be. In a further alternate embodiment the reinforcing layer could be comprised of a non-woven extruded sheet, a spunbond product, CLAF ™, netting, a knit fabric, a cross laminated fabric, or other such product. Regardless of the particular construction of reinforcing layer 2, in the preferred embodiment of the invention the layer has a first side 8, a second side 9, and a plurality of openings or passageways 10 extending through the layer and between sides 8 and 9 that render the layer breathable. Where the reinforcing layer is comprised of a woven scrim passageways 10 will be comprised of the spaces between adjacent and crossing warp and weft tapes, threads or filaments. Where the reinforcing layer is a non-woven or extruded product, openings 10 may be specifically designed within its structure, the layer may be perforated or cut to form openings 10, or there may otherwise exist small openings through the layer as a result of its method of manufacture (for example, in the case of a spunbond product). Although not critical to the invention, it is expected that in most instances reinforcing layer 2 will be formed with a weight of between approximately 10 and approximately 100 grams per square metre.

Referring again to FIG. 1, fabric 1 includes a breathable barrier layer 5 that serves as the primary means to render the fabric water resistant, or waterproof as the case may be. To that end the barrier layer may be comprised of a microporous film or a monolithic breathable layer that is capable of allowing the transfer of water vapour due to chemical absorption, transference through the layer thickness and then release on the other side. In one of the preferred embodiments of the invention barrier layer 5 is a laminate extrudate in the form of a monolithic coating applied to first side 8 of reinforcing layer 2. There are a variety of different extrudates that may be utilized as barrier layer 5, each having water resistant and breathability characteristics. One such product is produced by Polymer Group, Inc and is described in U.S. Pat. No. 6,191,221, dated Feb. 20, 2001. It should also be noted that the extrudate may be produced in virtually any desired colour and may include ultraviolet and/or heat stabilizers, flame retardants, hydrophobic agents, foam agents, nanotubules or other additives where deemed advantageous in consideration of the end use of the fabric.

The applicant has found that a laminate extrudate formed generally from a copolyester-ethylene methacrylate (EMA) mixture (for example, a blend of Arnitel PL 380™ from Dutch State Mines™ and Ateva 1815™ from AT Plastics™) functions well as a barrier layer in fabric 1. It will be understood that in general the degree of breathability of a layer of such laminate extrudate will be related to its thickness, in that the thicker the layer the less breathable it becomes. As is discussed in further detail below, the stiffness or rigidity of the layer is also a function of its thickness with thicker layers generally being more rigid. The applicant has further determined that when applied over reinforcing layer 2 at a thickness of approximately 0.025 mm (from approx 10 to 40 grams per square metre) the laminate extrudate of the present invention exhibits a reasonable degree of rigidity while remaining sufficiently breathable. Of course other thicknesses of extrudate could also be used for particular applications that require specific degrees of breathability.

Regardless of the particular extrudate that is used, as indicated in FIG. 1, where the reinforcing layer is a woven scrim or otherwise has sufficiently large openings through it, applying a coating of the extrudate over first side 8 of reinforcing layer 2 will cause some of the extrudate to be forced through openings or passageways 10 within the reinforcing layer and extend out through second side 9. In this manner the extrudate will be present on both sides of reinforcing layer 2 and represents a means by which both the first and second protective layers may be adhered to the reinforcing layer to form a multi-layered composite material or fabric. Such a structure removes the need for the use of complex and costly breathable adhesives or secondary bonding materials and processes.

With a thorough understanding of the invention one of skill in the art will realize that there will also exist other manners in which to securely hold the various layers of fabric 1 together. For example, first or upper protective layer 3 could be adhered to reinforcing layer 2 by means of the laminate extrudate, after which the combination of layers 2, 3 and 5 could be bonded to second or lower protective layer 4 through the use of an adhesive, through heat bonding or by way of ultrasonic lamination. It will also be appreciated that the laminate extrudate could be applied to opposite sides of the reinforcing layer through using a two pass coating technique. In that case it may not be necessary to ensure that the extrudate completely covers either side of the reinforcing layer as long as there is sufficient coverage of the reinforcing layer (on one side, the other side or both sides together) to render the fabric water resistant.

The nature of the composition and construction of the barrier layer tends to make it a relatively fragile component and susceptible to becoming damaged to the point that the water resistency of the fabric may be compromised. It will thus be appreciated that with the utilization of upper and lower protective layers encompassing the intermediary barrier layer, the barrier layer will be protected from damage that may otherwise occur during shipment, application and use of fabric 1. Pores, micropores, or passageways extending through each of the protective layers render them breathable in order for the multi-layered construction of fabric 1 remain breathable. The respective protective layers could be comprised of a wide variety of different materials while still performing their intended function of protecting barrier layer 5 from damage. For example, the protective layers may be formed from woven, non-woven (including needlepunch and hydroentangled) or extruded products. Alternatively, the protective layers could be constructed from paper, modified bitumen, asphalt, adhesives or other products. There is also no specific need for both protective layers to be of the same construction or composition. However, in each instance the protective layers should be breathable in order to ensure the overall breathability of fabric 1.

In one of the preferred embodiment of the invention first end second protective layers 3 and 4 are comprised of spunbond polypropylene having a weight of from approximately 0.25 ounces per square yard to approximately 2 ounces per square yard. One or both of the protective layers also preferably include ultraviolet and heat stabilizers in order to prevent their degradation when exposed to sunlight and elevated temperatures, particularly where the fabric is to be used as a roofing underlayment. In addition, for roofing applications it has been found desirable to colour the protective layers a grey colour since grey tends to absorb less heat from sunlight and is also less reflective than bright colours (for example white) and thereby less harsh on the eyes of installers. In other cases the protective layers may be manufactured in any one of a wide variety of other colours, and the two layers may be of different colours if desired. In some instances it may also be desirable to include a metallized, reflective, hydrophobic, or hydrophilic coating on one or both of the protective layers.

While in the embodiment of the invention shown in FIG. 1 both first and second protective layers are generally of an identical construction, in an alternate embodiment the layers could be formed from different materials or could have different physical structures (for example one layer may be woven with the other layer non-woven). Once again, depending upon the intended application for fabric 1 either the first and/or second protective layers may also provide an anti-slip or anti-skid exterior surface to the fabric. For example, where the fabric may be exposed to foot traffic an anti-slip surface may be necessary or desirable for safety purposes. Where the protective layers are formed from materials such as spunbond polypropylene, the nature of the material itself inherently provides an anti-skid surface. In other cases where the protective layers are formed from materials that have no inherent anti-skid properties any one of a number of commonly utilized methods or materials for protecting against slipping may be used.

The invention also provides for a method of manufacturing a multi-layered breathable water-resistant fabric such as that shown in FIG. 1 and described above. The method includes extrusion laminating upper and lower protective layers 3 and 4 to opposite sides of reinforcing layer 2 through the use of a laminate extrudate that in one instance covers the first side of reinforcing layer 2 and in another instance extends through the opening or passageways within the reinforcing layer. As described above, in this manner the extrudate provides a means to adhere the upper protective layer to the remainder of the fabric while at the same time the portions of the extrudate that extend through the openings in the reinforcing layer provide a means to adhere the lower protective layer to the fabric. The result is a breathable water-resistant fabric that may be manufactured relatively quickly and easily through a single extrusion laminating step without the need for bonding or laminating individual layers together in separate stages. The method also removes the necessity to use additional heat, adhesives or other processes or materials to adhere the layers of the multi-layered fabric together.

As mentioned previously, the general rigidity or stiffness of fabric 1 will to a certain extent be a function of the thickness of the extrudate used to form barrier layer 5. For particular applications it maybe desirable for fabric 1 to be relatively flexible permitting it to be formed or wrapped around particular objects. However, in other applications, such as when used as a roofing underlayment, it may desirable for the fabric to be somewhat more rigid or stiff to aid in its application. In such cases the rigidity or stiffness of the product could be enhanced in a number of different ways. As discussed previously, one such manner of increasing stiffness is through increasing the amount of polymer or the thickness of barrier layer 5. However, as also indicated previously, increasing the thickness of the barrier layer is normally at the expense of reducing breathability. Alternately, different materials or methods of manufacturing either the reinforcing layer or one or both of the protective layers could be employed to create a more rigid or stiffer product. In a further alternate embodiment a binder could be added to one or both of the protective layers (or the reinforcing layer) to act a stiffening agent. Such a binder could be applied through knife coating, spraying, printing or otherwise applying the binder to the surface of the respective layer or layers. While such processes are generally known in the art, it should be noted that care must be taken to ensure that where the stiffening or binding agent itself is not breathable the entire surface of the protective layer is not covered to ensure the breathability of the overall fabric.

In the preferred embodiments of the invention described above breathable water resistant fabric 1 is comprised of a multi-layered structure wherein a reinforcing layer and barrier layer are sandwiched between an upper and lower protective layer. In an alternate embodiment the fabric may be constructed without the lower or second protective layer in place. In such a case the lower surface of the fabric would essentially be comprised of reinforcing layer 2 with breathable barrier layer 5 sandwiched between the reinforcing layer and the upper protective layer. As in the case of the previously described embodiments, the barrier layer would provide water resistency to fabric 1 and also provide a means by which the protective layer may be bonded or adhered to the reinforcing layer without the need for the use of complex and costly breathable adhesives or secondary bonding materials and/or processes. Such a construction of fabric 1 may be of use in applications where an extremely light weight product is desired, or where the likelihood of damage occurring to the lower side of the fabric causing a breach in the barrier layer is relatively low. In such instances it may sometimes be desirable to utilize a non-woven reinforcing layer as a means of potentially providing a somewhat enhanced degree of protection to the more fragile barrier layer.

It will thus be appreciated that the breathable water-resistant fabric of the present invention may be used as a cover, tarpaulin, roofing enclosure, housewrap, roofing underlayment, or for any one of a wide variety of other applications where a breathable water-resistant material is required. The structure of the product presents a relatively strong fabric that is water resistant (or waterproof as the case may be) while remaining breathable. Tests have shown that products constructed in accordance with the above described preferred embodiments demonstrate tensile strengths greater than 25 pounds per inch and water vapour transmission rates of between 3 and 100 perms (however, alternate embodiments could exhibit enhanced strength and increased rates of water vapour transmission). The formation of the product from polypropylene, polyesters or other polyolefins also ensures a relatively light weight finished product that is generally easy to install and that is mold resistant. The utilization of protective layers to prevent damage to the more fragile barrier layer helps to prevent a breach of the barrier layer during transportation, installation and use. The particular structure of the fabric also facilitates in its manufacturing and allows for its various layers to be bonded together easily, quickly and without the use of additional binders, adhesives or other materials.

It is to be understood that what has been described are the preferred embodiments of the invention and that it may be possible to make variations to these embodiments while staying within the broad scope of the invention. Some of these variations have been discussed while others will be readily apparent to those skilled in the art.

1. A breathable, water resistant fabric comprising:
a reinforcing layer having a first side and a second side and including a plurality of openings or passageways extending between said first and said second sides to render the reinforcing layer breathable;
a barrier layer applied to said reinforcing layer such that said barrier layer imparts water resistance to said reinforcing layer while maintaining the breathability of said fabric to permit the movement of water vapor therethrough, wherein said barrier layer comprises a laminate extrudate comprising a monolithic breathable film capable of allowing transfer of water vapor therethrough via chemical absorption; and,
a breathable first protective layer covering at least a portion of said barrier layer.

2. The fabric as claimed in claim 1 wherein said barrier layer is a laminate extrudate.

3. The fabric as claimed in claim 1 wherein said laminate extrudate further serves to bond said first protective layer to said reinforcing layer to thereby form a multi-layered fabric.

4. The fabric as claimed in claim 3 including a breathable second protective layer, said second protective layer positioned on the opposite side of said reinforcing layer from said first protective layer, said laminate extrudate extending through a plurality of said openings in said reinforcing layer and further serving to bond said second protective layer to said reinforcing layer.

5. The fabric as claimed in claim 1 wherein said reinforcing layer is a woven scrim.

6. The fabric as claimed in claim 1 wherein said reinforcing layer is a perforated sheet.

7. The fabric as claimed in claim 4 wherein said first and said second protective layers are non-woven products.

8. The fabric as claimed in claim 4 wherein said first and said second protective layers are formed from spunbond polypropylene.

9. The fabric as claimed in claim 1 wherein said first protective layer provides anti-skid exterior surface to said fabric.

10. The fabric as claimed in claim 1 wherein said first protective layer includes an ultraviolet stabilizer.

11. The fabric as claimed in claim 1 wherein said barrier layer is a microporous film and includes micropores or micropassageways of a size that permit the passage of water vapor therethrough while preventing the transmission of liquid water through said fabric.

12. The fabric as claimed in claim 2 wherein said laminate extrudate is a monolithic breathable film.

13. The fabric as claimed in claim 1 used as a roofing underlayment or housewrap.

14. A multi-layered breathable water resistant fabric comprising:
upper and lower protective layers, each of said protective layers containing pores, openings or passageways extending therethrough to render the layers breathable and to permit the transmission of water vapor through said layers; an intermediate reinforcing layer positioned between said upper and said lower protective layers, said reinforcing layer providing strength to said fabric and including pores, openings or passageways extending therethrough rendering said reinforcing layer breathable; and,
a barrier layer comprising a laminate extrudate applied to a first side of said reinforcing layer such that said extrudate covers said first side of said reinforcing layer thereby imparting water-resistance to said fabric while maintaining the breathability of said fabric to permit the flow of water vapor therethrough, wherein said laminate extrudate comprises a monolighic breathable film capable of allowing transfer of water vapor therethrouqh via chemical absorption.

15. The fabric as claimed in claim 14 wherein said laminate extrudate comprising said barrier layer when applied to said first side of said reinforcing layer extends through said openings in said reinforcing layer and provides a means to adhere said lower protective layer to said reinforcing layer.

16. The fabric as claimed in claim 15 wherein said laminate extrudate comprising said barrier layer provides a means to adhere said upper protective layer to said reinforcing layer.

17. The fabric as claimed in claim 16 wherein said reinforcing layer is a woven scrim.

18. The fabric as claimed in claim 14 wherein said barrier layer includes micropores or passageways of a size that permits the passage of water vapor therethrough while preventing the transmission of liquid water through said fabric.

19. A method of manufacturing a multi-layered breathable water resistant fabric, the method comprising extrusion laminating an upper protective layer and a lower protective layer to opposite sides of a reinforcing layer through the use of a laminate extrudate, said reinforcing layer including a plurality of openings or passageways extending therethrough, said laminate extrudate covering first side of said reinforcing layer and providing a means to adhere said upper protective layer to said multi-layered fabric, said laminate extrudate further extending through said openings in said reinforcing layer and providing a means to adhere said lower protective layer to said multi-layered fabric, wherein said upper and said lower protective layers are breathable and said laminate extrudate comprises a barrier layer imparting water resistance to said fabric while maintaining breathability to permit the flow of water vapor therethrough.

20. The fabric as claimed in claim 1 wherein said laminate extrudate comprises a copolyester-ethylene methacrylate mixture.

21. The fabric as claimed in claim 1 wherein said laminate extrudate is applied to a side of the reinforcing layer at approximately 10 to 40 grams per square meter.

22. The fabric as claimed in claim 1 wherein said laminate extrudate is applied to a side of the reinforcing layer at a thickness of approximately 0.025 mm.

23. The fabric as claimed in claim 1 wherein said fabric is sufficiently flexible to allow said fabric to be formed or wrapped around objects.

24. The fabric as claimed in claim 14 wherein said laminate extrudate comprises a copolyester-ethylene methacrylate mixture.

25. The fabric as claimed in claim 14 wherein said laminate extrudate is applied to said first side of said reinforcing layer at approximately 10 to 40 grams per square meter.

26. The fabric as claimed in claim 14 wherein said laminate extrudate is applied to a side of the reinforcing layer at a thickness of approximately 0.025 mm.

27. The fabric as claimed in claim 14 wherein said fabric is sufficiently flexible to allow said fabric to be formed or wrapped around objects.
